(19) United States
(12) Patent Application Publication
(10) Pub. No.: US 2025/0245549 A1
(43) Pub. Date: Jul. 31, 2025

(54) ML/AI MODEL COMPARISON AND SELECTION BASED ON OBJECTIVE FUNCTIONS

(71) Applicant: Cisco Technology, Inc., San Jose, CA (US)

(72) Inventors: Ali Payani, Santa Clara, CA (US); Myungjin Lee, Bellevue, WA (US); Ramana Rao V.R. Kompella, Foster City, CA (US)

(21) Appl. No.: 18/423,699

(22) Filed: Jan. 26, 2024

(51) Int. Cl. G06N 20/00

(52) U.S. Cl. CPC G06N 20/00

(57) ABSTRACT

In one embodiment, an illustrative process herein may comprise: accessing, by a device, a plurality of machine learning models; determining, by the device, one or more objective functions for the plurality of machine learning models; evaluating, by the device, the plurality of machine learning models against the one or more objective functions to establish a comparative assessment of each of the plurality of machine learning models for the one or more objective functions; and providing, by the device, the comparative assessment of each of the plurality of machine learning models to a model selection process for selection of a specific machine learning model from the plurality of machine learning models for a given objective function of the one or more objective functions.

### TECHNICAL FIELD

The present disclosure relates generally to computer networks, and, more particularly, to machine learning/artificial intelligence (ML/AI) model comparison and selection based on objective functions.

### BACKGROUND

Recent advances in machine learning (ML) and artificial intelligence (AI) have led to the proliferation of ML/AI models for a wide variety of purposes. For instance, some ML/AI models are now used for purposes of video analytics (e.g., surveillance systems), assessing and controlling the operations of computer networks, overseeing complex sensor systems, among other uses.

With the wide variety of use cases nowadays, selecting the appropriate ML/AI model for deployment remains challenging. In general, model selection typically entails finding a model that exhibits a desired balance of model objectives that are considered suitable for the task. Today, this process is largely done through the use of trial and error and using a hyperparameter optimization approach, such as grid search, at various intervals. Besides being cumbersome and resource intensive, this process is often repeated from scratch whenever the objectives of the model are changed.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example representation of ML/AI models and objective functions;

FIG. 4 illustrates an example of a model project checkpointing user interface;

FIG. 5 illustrates an example of a model project lineage user interface;

FIG. 6 illustrates an example chart of ML/AI model comparison;

FIG. 7 illustrates an example of an objective function collection;

FIG. 8 illustrates an example of an objective function design; and

FIG. 9 illustrates an example simplified procedure for ML/AI model comparison and selection based on objective functions in accordance with one or more embodiments described herein.

### DESCRIPTION OF EXAMPLE EMBODIMENTS

### Overview

According to one or more embodiments of the disclosure, an illustrative process herein may comprise: accessing, by a device, a plurality of machine learning models; determining, by the device, one or more objective functions for the plurality of machine learning models; evaluating, by the device, the plurality of machine learning models against the one or more objective functions to establish a comparative assessment of each of the plurality of machine learning models for the one or more objective functions; and providing, by the device, the comparative assessment of each of the plurality of machine learning models to a model selection process for selection of a specific machine learning model from the plurality of machine learning models for a given objective function of the one or more objective functions.

In one implementation, the techniques herein may also create one or more checkpoints during development of a specific machine learning model; and establish one or more selectable machine learning model versions of the specific machine learning model that each correspond to a respective configuration of the specific machine learning model at a respective checkpoint of the one or more checkpoints, wherein the plurality of machine learning models comprise the one or more selectable machine learning model versions. In still a further implementation, the techniques herein may also track a lineage of each of the one or more selectable machine learning model versions, accordingly.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

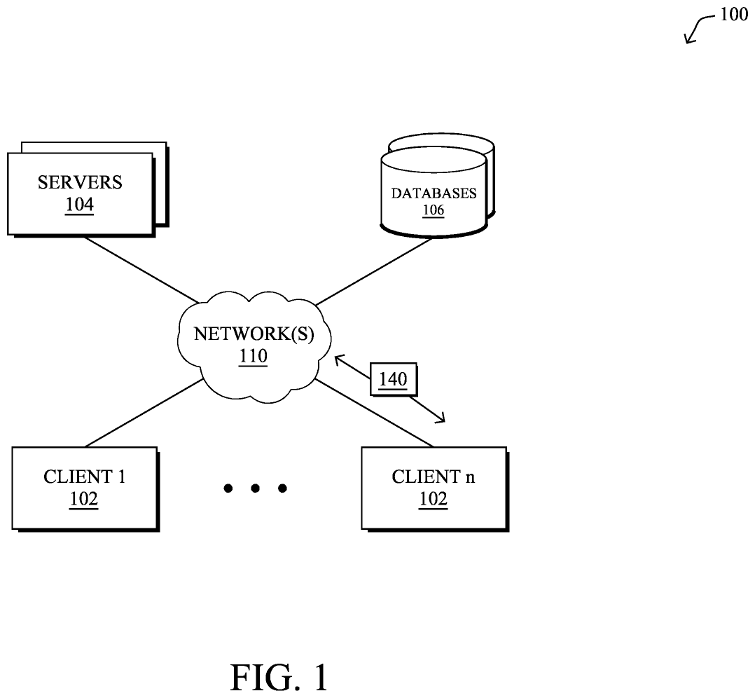

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

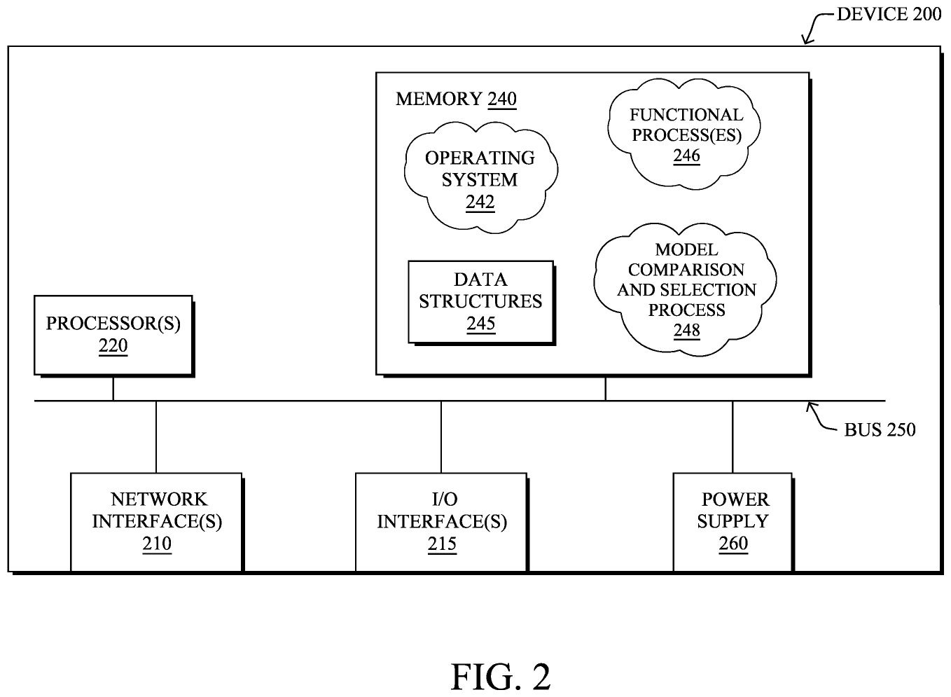

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a model comparison and selection process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, model comparison and selection process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —ML/AI Model Comparison and Selection—

As noted above, machine learning (ML) and artificial intelligence (AI) models are used for a wide variety of purposes, though selecting the appropriate ML/AI model for deployment remains challenging. In general, model selection typically entails finding a model that exhibits a desired balance of model objectives that are considered suitable for the task, where such objectives could include, for instance, the accuracy of the model, the fairness of the model, and the like. As also noted above, this process is largely done today through the use of trial and error and using a hyperparameter optimization approach, such as random search or grid search, at various intervals. Besides being cumbersome and resource intensive, this process is often repeated from scratch whenever the objectives of the model are changed.

The techniques herein, therefore, aid in the selection of ML/AI models to satisfy a stated objective. In particular, the techniques herein introduce a model selection approach that is based on a specified objective function and by comparing various models and their suitability for that specified objective function. Some aspects of the techniques herein also provide for creating “checkpoints” within the progression of an ML/AI model, so that the process does not need to be restarted from the beginning, should the objectives (objective functions) change over time, and different versions of the ML/AI model may be selected based on these checkpoints, accordingly.

Specifically, according to one or more embodiments of the disclosure as described in detail below, an illustrative process herein may comprise: accessing, by a device, a plurality of machine learning models; determining, by the device, one or more objective functions for the plurality of machine learning models; evaluating, by the device, the plurality of machine learning models against the one or more objective functions to establish a comparative assessment of each of the plurality of machine learning models for the one or more objective functions; and providing, by the device, the comparative assessment of each of the plurality of machine learning models to a model selection process for selection of a specific machine learning model from the plurality of machine learning models for a given objective function of the one or more objective functions.

Also, in one specific implementation, the techniques herein may also create one or more checkpoints during development of a specific machine learning model; and establish one or more selectable machine learning model versions of the specific machine learning model that each correspond to a respective configuration of the specific machine learning model at a respective checkpoint of the one or more checkpoints, wherein the plurality of machine learning models comprise the one or more selectable machine learning model versions. In still a further implementation, the techniques herein may also track a lineage of each of the one or more selectable machine learning model versions, accordingly.

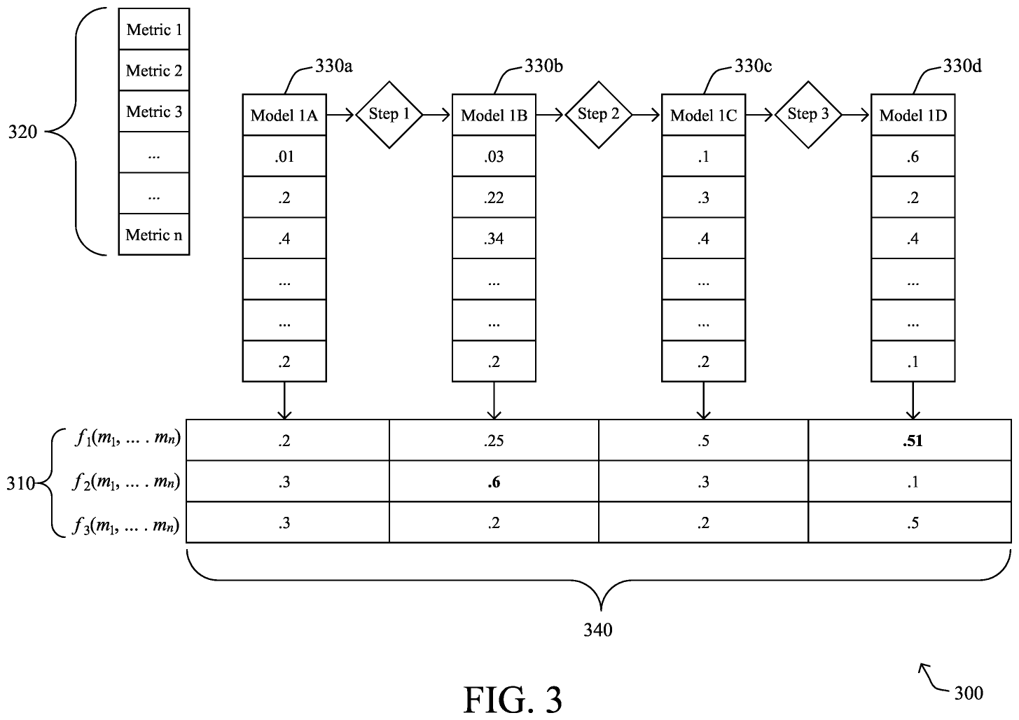

Operationally, and with reference to FIG. 3 which illustrates an example representation 300 of ML/AI models and objective functions, where objective functions 310 are defined as a mix of parameters, such as a mathematical function of metrics, and various constraints. An objective function, in particular, is a critical component in ML/AI that encapsulates the optimization criteria for machine learning and deep learning models, serving as the “goal” that enables ML/AI systems to adapt and improve their performance over time. That is, the objective function (or criterion) is needed to solve optimization problems, and ML/AI algorithms are directed toward maximizing (or minimizing) the value of its objective function. This function, taking data and model parameters as arguments, can be evaluated to return a number, thus providing a mechanism for measuring the quality of any solution. (One example of a “comparative assessment” herein is this returned number, which may be used as a comparison to other solutions offered by other models to determine the “suitability” of each model for that specific objective function, accordingly.)

In particular, objective functions 310 (e.g., ƒ₁-ƒ₃) in general may be based on a collection of metrics 320 (e.g., metric 1, metric 2, . . . metric n, also denoted as m₁, . . . mₙ). ML/AI models 330 (e.g., model 1A 330a, model 1B 330b, model 1C 330c, model 1D 330d, etc.) may also be separate models, or as shown, may be a step-by-step progression through model versions (or “checkpoints” as described in greater detail below).

According to the techniques herein, each objective function can be defined with a specific utility in mind, such as, e.g., accuracy, fairness, accuracy with fairness constraints, performance, etc. Also, unlike current solutions, these objectives can be defined in a “lazy manner”, for example, using “lazy constraints” (e.g., that the user knows are unlikely to be violated, and in consequence, need only be applied as necessary).

As mentioned above, the techniques herein further provide for the creation of “checkpoints,” allowing the system to go back and find a version of the model that is suitable for a given objective. This is particularly useful in the case of the design objectives changing later on in the development lifecycle.

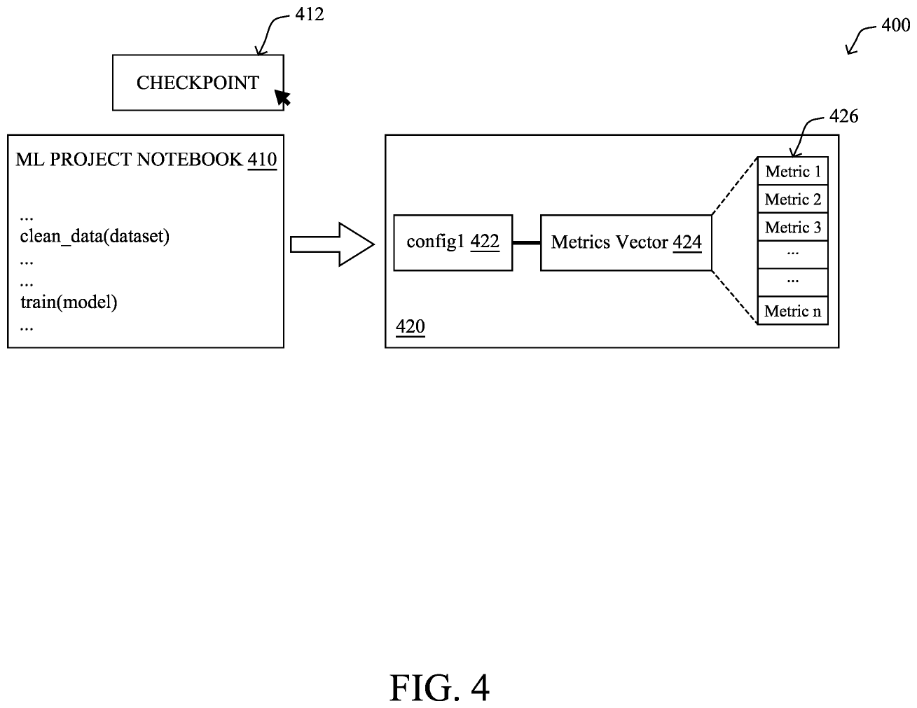

An example user interface is shown in FIG. 4, illustrating an example of a model project checkpointing user interface (interface 400). For instance, as shown in the example, an ML project notebook 410 may be presented to a user, with an option at any point during the development to select a checkpoint option 412 (e.g., an icon, button, trigger, or command line interface (CLI) command, and so on). That is, a developer can perform checkpointing whenever it is deemed necessary. Since the ML/AI model development is an iterative process, which involves many steps and revisions, checkpointing allows the developer to keep track of the history of these steps.

For instance, at one step, the ML project notebook 410 has “data cleaning” and “train” stages. But during a revision step, the developer may wish to introduce, for example, an “outlier detection” stage between the former two stages. As another variation, the user may wish to tweak parameters of the existing stages. All of these steps would produce a configuration and its corresponding metrics vector. As such, prior to modifying the project, the developer may want to “save their progress” in order to potentially return to this version at a later time, as described herein.

Illustratively, when checkpoint option 412 is selected (e.g., clicked, pressed, written, etc.), the system automatically saves configuration/state and computes associated metrics. As shown in display 420, a configuration 422 (“config1”) at that checkpointed time has an associated metric vector 424 comprising the related metrics 426 (e.g., metric 1, metric 2, . . . metric n), accordingly.

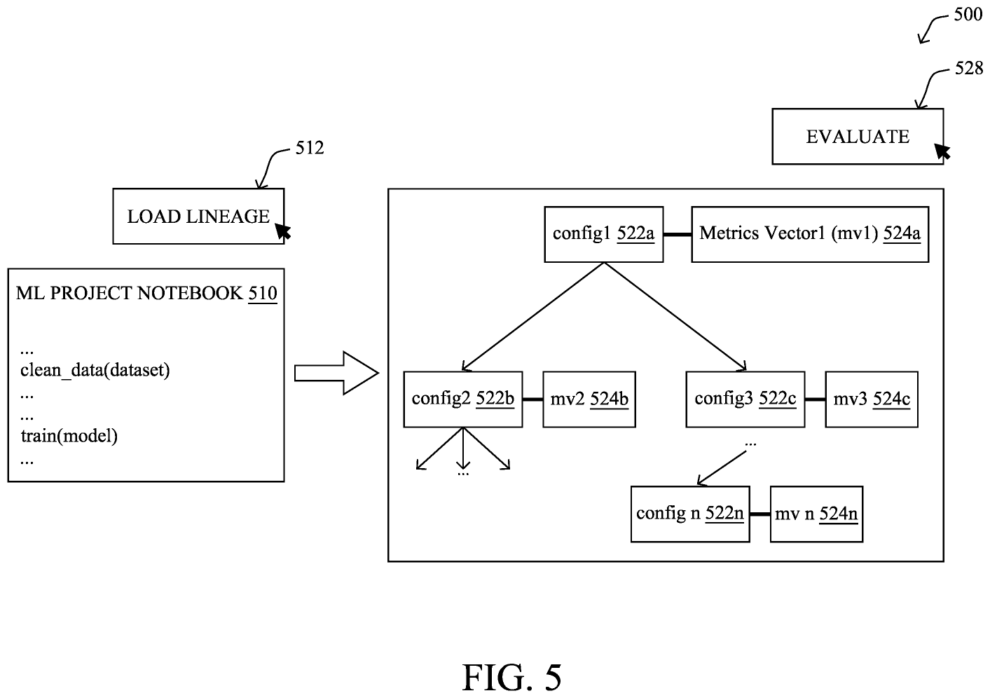

Additionally, the system herein keeps track of lineage among the checkpoints. That is, with reference now to FIG. 5, illustrating an example of a model project lineage user interface (interface 500), a developer in an ML project notebook 510 can select “load lineage” option, (load lineage option 512, such as an icon, button, trigger, or CLI command, and so on) to load the lineage of an ML project. The lineage is updated every time “checkpoint” button above is clicked. The lineage itself may be shown in a lineage display 520, such as showing each stored configuration 522 and metric vector 524, as illustrated in FIG. 4 above, but with lineage connections indicating the progression between checkpointed versions of the ML model project. For instance, as shown, configuration 522a corresponds to “config1” with metrics 524a of “metric vector1” (or “mv1”), which then shows two separated branches to configuration 522b (“config2” with metrics 524b “mv2”) and configuration 522c (“config3” with metrics 524c “mv3”). The configuration “config3” may have then led to another revision toward configuration 522n (“config n” with metrics 524n “mv n”), and so on, in a corresponding lineage tree, accordingly.

In one implementation herein, upon selecting an “evaluate” option, (evaluate option 528, such as an icon, button, trigger, or CLI command, and so on), the system herein may invoke a set of user-defined objective functions against the metrics vectors for each of the configurations of a plurality of ML/AI models, such as the different configurations/versions of a particular project (e.g., as shown in the lineage display 520), or else from any collection of comparable ML/AI models selected by a developer to compare.

Specifically, during an evaluation, the system herein evaluates the individual configurations and its ML/AI model with regard to particular objective functions so that the developer knows what model and configuration is best suited for a particular objective.

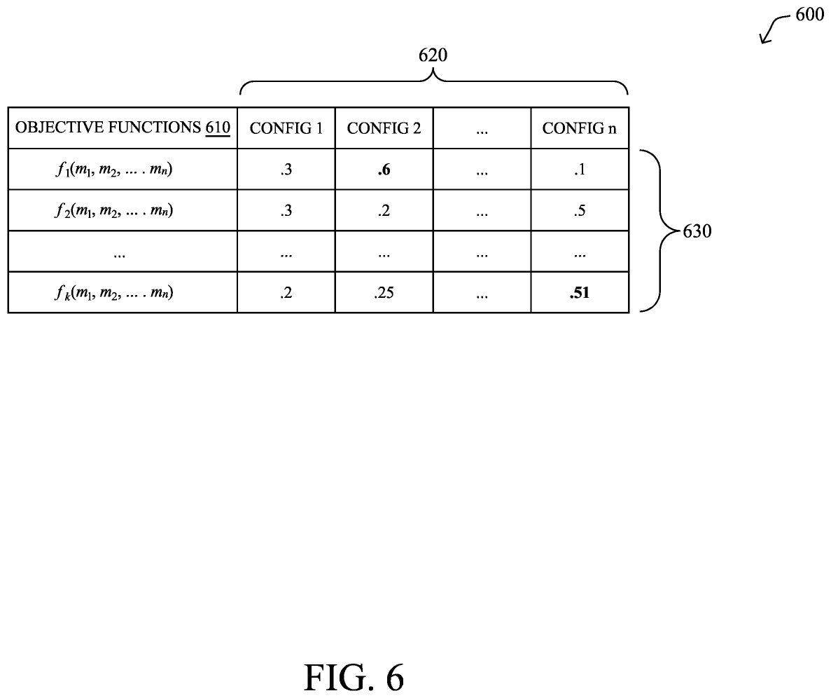

For example, FIG. 6 illustrates an example chart (chart 600) of ML/AI model comparison based on such an evaluation. Various objective functions 610 within the chart (e.g., ƒ₁, ƒ₂, . . . ƒₖ) may be invoked against the various configurations (configurations 620), such as “config1”, “config2”, . . . “config n” of a particular checkpointed/versioned ML/AI model, or else alternatively to configuration(s) of different models entirely.

As shown in FIG. 6, entries 630 with in the chart 600 are the result (e.g., a score, assessment, rank, etc.) of “suitability” for a given ML/AI model configuration for a particular objective function. The calculation of these results may be based on any comparative assessment scale, such as between “unsuitable” (e.g., a “0.0”) and “perfect” (e.g., a “1.0”), a “low, medium, high” suitability ranking, or any other appropriate comparison mechanism. As shown, for example, “config2” may be the most suitable for objective function “ƒ₁” (e.g., a “0.6” suitability score, as compared to “0.3,” “0.1,” etc.), while “config n” may be the most suitable for objective function “ƒₖ” (e.g., a “0.51” suitability score, as compared to “0.2,” “0.25,” etc.). In certain implementations, a highlighting of particularly suitable models for objective functions may be shown in the displayed chart, such as by bolding the value, highlighting the value, changing color of the entry, and so on. Various thresholds may be used for such highlighting herein (e.g., “any value greater than 0.5”), or such highlighting may be based on presentation of the best/most suitable selections.

Notably, unlike current solutions, these objectives can be defined in a lazy manner, and at a late point in development when the design objective changed. Specifically, since for each point in development where a checkpoint was created, the techniques herein will have already calculated all of the metrics, allowing a developer to go back and find a particular checkpointed version of a given model (or a particular model from a plurality of different models) that is suitable (e.g., most suitable) for the newly defined objective, without the need to redo all of the development steps, accordingly.

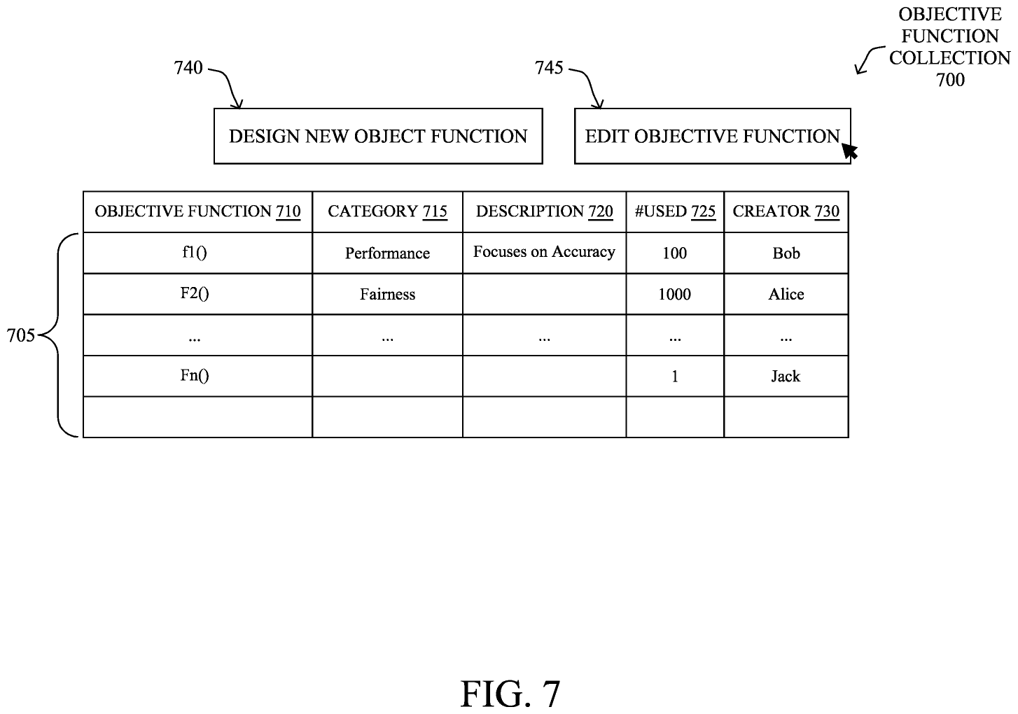

In addition, the techniques herein further allow for the creation and cataloging of different objective functions. For instance, with reference to FIG. 7, illustrating an example of an objective function collection 700, a plurality of entries 705 within a chart (e.g., the objective function collection 700) may optionally provide, for each objective function 710, a particular category 715 and a description 720, various tracking metrics such as number of times the objective function has been used (“#used” 725), a creator 730 of the objective function, and other fields as may be deemed useful for cataloging the objective functions. Selection options, such as “design new objective function” 740 and “edit objective function” 745 may also be presented, such as through icons, buttons, etc. within the display presented to the developer.

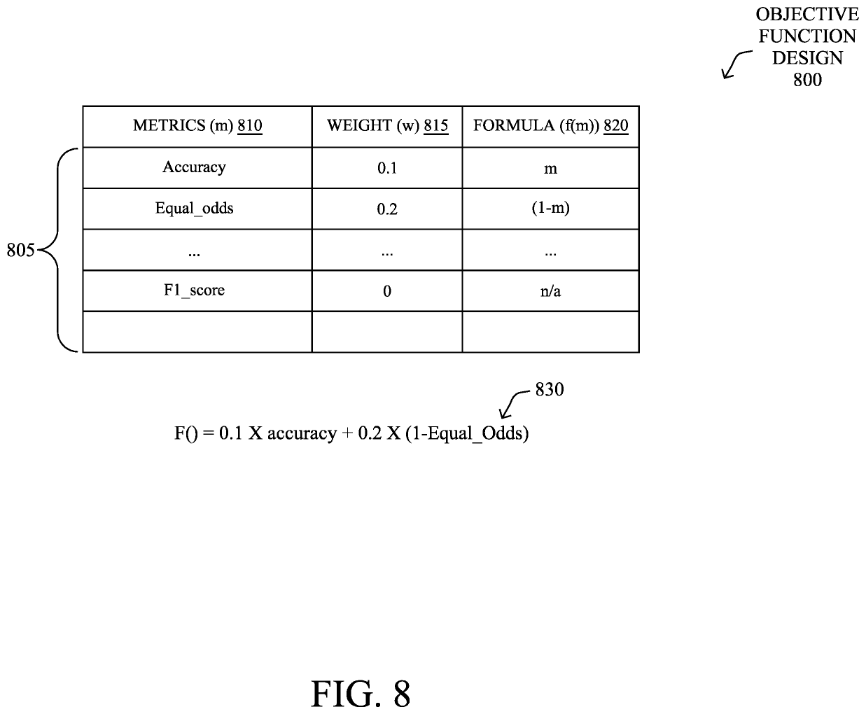

For example, FIG. 8 illustrates an example of an objective function design 800, such as in response to selecting either of the selection options in FIG. 7 to either design (create) or edit an objective function, accordingly. As shown, design entries 805 may be presented for a developer to edit certain configuration values, such as defining metrics 810 (e.g., “accuracy”, “equal_odds”, “F1_score”, and so on), as well as an associated weight 815 (e.g., 0.1, 0.2, 0, etc.) and corresponding defined formula 820 (e.g., “(f(m))”, such as “m”, “(1-m)”, n/a, etc.). The result of such configuration is the objective function 830, such as:

$$“ F ( ) = 0.1 \times accuracy + 0.2 \times ( 1 - Equal\_odds ) ” .$$

Other configurations of objective functions and catalogs of such objective functions may be designed into a system in accordance with the techniques described herein, and those formats and example values shown herein are merely an example and are not meant to limit the scope of the embodiments herein.

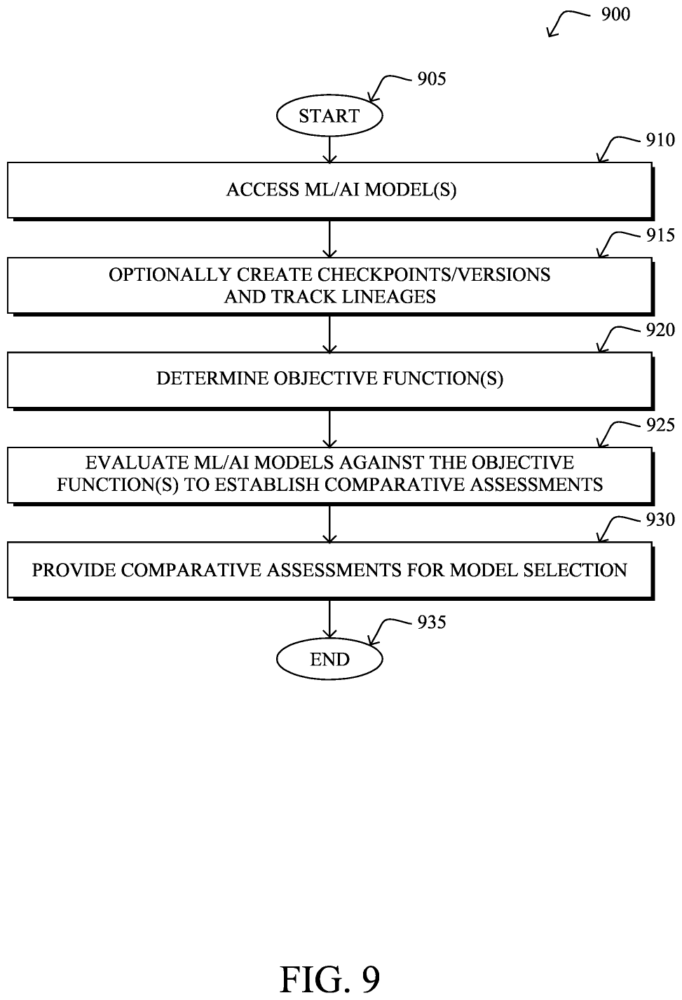

In closing, FIG. 9 illustrates an example simplified procedure for ML/AI model comparison and selection based on objective functions in accordance with one or more embodiments described herein. For example, a non-generic, specifically configured device (e.g., device 200, an apparatus) may perform procedure 900 by executing stored instructions (e.g., process 248). The procedure 900 may start at step 905, and continues to step 910, where, as described in greater detail above, the device accesses a plurality of machine learning models (e.g., stored locally, remotely, etc.), such as a plurality of disparate machine learning models, a plurality of different versions of a same machine learning model (e.g., checkpointed), or a combination of both.

In step 915, in certain implementations, the device may optionally create one or more checkpoints during development of a specific machine learning model as described above (e.g., in response to a manual user selection), thus establishing one or more selectable machine learning model versions of the specific machine learning model that each correspond to a respective configuration of the specific machine learning model at a respective checkpoint of the one or more checkpoints (where the plurality of machine learning models in step 910 comprise the one or more selectable machine learning model versions). Note that as detailed above, creating the checkpoints may comprise computing a respective metrics vector for the one or more selectable machine learning model versions at their respective checkpoint, and saving the respective metrics vector with the respective configuration for each of the one or more selectable machine learning model versions. Also in step 915, the device may optionally track a lineage of each of the one or more selectable machine learning model versions, accordingly, as mentioned above.

In step 920, the device may also determine one or more objective functions for the plurality of machine learning models. For instance, as illustrated above, the techniques herein may create a catalog of different objective functions from which to select as the one or more objective functions against which the plurality of machine learning models are evaluated (below), where the one or more objective functions may each be associated with a respective specific utility (e.g., a group consisting of accuracy, fairness, accuracy with fairness constraints, performance, etc.).

In step 925, the device may evaluate the plurality of machine learning models against the one or more objective functions to establish a comparative assessment of each of the plurality of machine learning models for the one or more objective functions. As explained above, evaluation may comprise invoking each of the one or more objective functions against metrics vectors for configurations of each of the plurality of machine learning models to determine suitability of each of the plurality of machine learning models for each of the one or more objective functions. As such, the comparative assessment of each of the plurality of machine learning models may be things such as a score (e.g., numeric, such as 1-10, 1-100, 0.0-1.0, etc.), a ranking (e.g., first, second, third, etc.), a grade (e.g., “A-F”), a tiered rating system (e.g., “poor, good, great”; “good, better, best”; etc.), and so on.

In step 930, the device may then provide the comparative assessment of each of the plurality of machine learning models to a model selection process for selection of a specific machine learning model from the plurality of machine learning models for a given objective function of the one or more objective functions. For instance, the model selection process may be a user interface displaying the comparative assessment of each of the plurality of machine learning models for user selection, as shown above (e.g., any of the comparative charts shown above). In alternative or additional embodiments, an auto-selection process may be based on finding a best comparative assessment according to a selected objective function of the one or more objective functions. For example, after inputting a given objective function, the system herein may determine the “best” machine learning model to use based on the comparative assessments for that given objective function, accordingly.

Procedure 900 may end at step 935.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process, when executed, configured to: access a plurality of machine learning models; determine one or more objective functions for the plurality of machine learning models; evaluate the plurality of machine learning models against the one or more objective functions to establish a comparative assessment of each of the plurality of machine learning models for the one or more objective functions; and provide the comparative assessment of each of the plurality of machine learning models to a model selection process for selection of a specific machine learning model from the plurality of machine learning models for a given objective function of the one or more objective functions.

In still other implementations, a tangible, non-transitory, computer-readable medium storing program instructions that cause a device to execute a process comprising: accessing a plurality of machine learning models; determining one or more objective functions for the plurality of machine learning models; evaluating the plurality of machine learning models against the one or more objective functions to establish a comparative assessment of each of the plurality of machine learning models for the one or more objective functions; and providing the comparative assessment of each of the plurality of machine learning models to a model selection process for selection of a specific machine learning model from the plurality of machine learning models for a given objective function of the one or more objective functions.

The techniques described herein, therefore, provide for ML/AI model comparison and selection based on objective functions. In particular, the techniques herein allow for the evaluative comparison between ML/AI models, whether different models or different checkpointed versions of an ML/AI model, based on their suitability for a given objective function. That is, the techniques herein alleviate the need for trial and error or hyperparameter optimization approaches, which are cumbersome and resource intensive, and also specifically alleviate the need to repeat such a process from scratch whenever the objectives of the model are changed.

Illustratively, the techniques described herein may be performed by hardware, software, and/or firmware, (e.g., an “apparatus”) such as in accordance with the model comparison and selection process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the intent and scope of the implementations herein. For example, while certain architectures, schemes, workloads, etc., are shown herein, the embodiments herein are not so limited.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
accessing, by a device, a plurality of machine learning models;
determining, by the device, one or more objective functions for the plurality of machine learning models;
evaluating, by the device, the plurality of machine learning models against the one or more objective functions to establish a comparative assessment of each of the plurality of machine learning models for the one or more objective functions; and
providing, by the device, the comparative assessment of each of the plurality of machine learning models to a model selection process for selection of a specific machine learning model from the plurality of machine learning models for a given objective function of the one or more objective functions.

2. The method of claim 1, further comprising:
creating one or more checkpoints during development of a specific machine learning model; and
establishing one or more selectable machine learning model versions of the specific machine learning model that each correspond to a respective configuration of the specific machine learning model at a respective checkpoint of the one or more checkpoints, wherein the plurality of machine learning models comprise the one or more selectable machine learning model versions.

3. The method of claim 2, further comprising:
tracking a lineage of each of the one or more selectable machine learning model versions.

4. The method of claim 2, wherein establishing the one or more selectable machine learning model versions of the specific machine learning model comprises:
computing a respective metrics vector for the one or more selectable machine learning model versions at their respective checkpoint; and
saving the respective metrics vector with the respective configuration for each of the one or more selectable machine learning model versions.

5. The method of claim 2, wherein creating the one or more checkpoints is in response to a manual user selection.

6. The method of claim 1, wherein evaluating comprises:
invoking each of the one or more objective functions against metrics vectors for configurations of each of the plurality of machine learning models to determine suitability of each of the plurality of machine learning models for each of the one or more objective functions.

7. The method of claim 1, wherein the model selection process comprises one of either a user interface displaying the comparative assessment of each of the plurality of machine learning models for user selection or an auto-selection process based on a best comparative assessment according to a selected objective function of the one or more objective functions.

8. The method of claim 1, wherein the plurality of machine learning models comprise either a plurality of disparate machine learning models, a plurality of different versions of a same machine learning model, or a combination of both.

9. The method of claim 1, wherein the one or more objective functions are each associated with a respective specific utility.

10. The method of claim 9, wherein each respective specific utility is selected from a group consisting of: accuracy; fairness; accuracy with fairness constraints; and
performance.

11. The method of claim 1, further comprising:
creating a catalog of different objective functions from which to select as the one or more objective functions against which the plurality of machine learning models are evaluated.

12. The method of claim 1, wherein the comparative assessment of each of the plurality of machine learning models is selected from a group consisting of: a score; a ranking; a grade; and a tiered rating system.

13. An apparatus, comprising:
one or more network interfaces to communicate with a network;
a processor coupled to the one or more network interfaces and configured to execute one or more processes; and
a memory configured to store a process that is executable by the processor, the process, when executed, configured to:
access a plurality of machine learning models;
determine one or more objective functions for the plurality of machine learning models;
evaluate the plurality of machine learning models against the one or more objective functions to establish a comparative assessment of each of the plurality of machine learning models for the one or more objective functions; and
provide the comparative assessment of each of the plurality of machine learning models to a model selection process for selection of a specific machine learning model from the plurality of machine learning models for a given objective function of the one or more objective functions.

14. The apparatus of claim 13, wherein the process, when executed, is further configured to:
create one or more checkpoints during development of a specific machine learning model; and
establish one or more selectable machine learning model versions of the specific machine learning model that each correspond to a respective configuration of the specific machine learning model at a respective checkpoint of the one or more checkpoints, wherein the plurality of machine learning models comprise the one or more selectable machine learning model versions.

15. The apparatus of claim 14, wherein the process, when executed, is further configured to:
track a lineage of each of the one or more selectable machine learning model versions.

16. The apparatus of claim 13, wherein the process, when executed to evaluate, is configured to:
invoke each of the one or more objective functions against metrics vectors for configurations of each of the plurality of machine learning models to determine suitability of each of the plurality of machine learning models for each of the one or more objective functions.

17. The apparatus of claim 13, wherein the model selection process comprises one of either a user interface displaying the comparative assessment of each of the plurality of machine learning models for user selection or an auto-selection process based on a best comparative assessment according to a selected objective function of the one or more objective functions.

18. The apparatus of claim 13, wherein the plurality of machine learning models comprise either a plurality of disparate machine learning models, a plurality of different versions of a same machine learning model, or a combination of both.

19. The apparatus of claim 13, wherein the one or more objective functions are each associated with a respective specific utility.

20. A tangible, non-transitory, computer-readable medium storing program instructions that cause a device to execute a process comprising:
accessing a plurality of machine learning models;
determining one or more objective functions for the plurality of machine learning models;
evaluating the plurality of machine learning models against the one or more objective functions to establish a comparative assessment of each of the plurality of machine learning models for the one or more objective functions; and
providing the comparative assessment of each of the plurality of machine learning models to a model selection process for selection of a specific machine learning model from the plurality of machine learning models for a given objective function of the one or more objective functions.
